(19) United States
(12) Patent Application Publication
(10) Pub. No.: US 2025/0061004 A1
(43) Pub. Date: Feb. 20, 2025

(54) TELEMETRY AND LOAD BALANCING IN CXL SYSTEMS

(71) Applicant: Micron Technology, Inc., Boise, ID (US)

(72) Inventors: Nikesh Agarwal, Village (IN); Chandana Manjula Linganna, Bangalore (IN); Ravi Kiran Gummaluri, Fremont, CA (US)

(21) Appl. No.: 18/777,251

(22) Filed: Jul. 18, 2024

(30) Foreign Application Priority Data
Aug. 16, 2023 (IN) 202311055015

(51) Int. Cl. G06F 9/50

(52) U.S. Cl. CPC G06F 9/505; G06F 9/5044

(57) ABSTRACT

A system can include a host configured to provide requests to, and receive responses from, multiple compute resources. In an example, the compute resources can be distributed on respective accelerator devices that can be configured to communicate with the host using various protocols, such as using compute express link (CXL). A first accelerator device can include a telemetry manager that can receive a queue utilization signal indicative of a volume of transaction request messages or response messages handled by the first accelerator device. The first accelerator device can determine a device loading metric about the first accelerator device based on the queue utilization signal, and can provide a control signal with information about the device loading metric to the host device. The host device can select the first accelerator device or a different device based on the control signal.

### PRIORITY APPLICATION

This application claims the benefit of priority to Indian patent application Ser. No. 202311055015, filed Aug. 16, 2023, which is incorporated herein by reference in its entirety.

### BACKGROUND

Memory devices for computers or other electronic devices may be categorized as volatile and non-volatile memory. Volatile memory requires power to maintain its data, and includes random-access memory (RAM), dynamic random-access memory (DRAM), or synchronous dynamic random-access memory (SDRAM), among others. Non-volatile memory can retain stored data when not powered, and includes flash memory, read-only memory (ROM), electrically erasable programmable ROM (EEPROM), static RAM (SRAM), erasable programmable ROM (EPROM), resistance variable memory, phase-change memory, storage class memory, resistive random-access memory (RRAM), and magnetoresistive random-access memory (MRAM), among others. Persistent memory is an architectural property of the system where the data stored in the media is available after system reset or power-cycling. In some examples, non-volatile memory media may be used to build a system with a persistent memory model.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

Various protocols or standards can be applied to facilitate communication between a host and one or more other devices such as memory buffers, accelerators, or other input/output devices. In an example, an unordered protocol such as Compute Express Link (CXL) can be used to provide high-bandwidth and low-latency connectivity.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates generally a block diagram of an example computing system including a host and a memory device.

FIG. 2 illustrates generally an example of a compute express link (CXL) system.

FIG. 3 illustrates generally an example of a CXL system implementing a virtual hierarchy for managing transactions.

FIG. 4A, FIG. 4B, FIG. 5A, FIG. 5B, and FIG. 5C illustrate generally respective examples of a CXL host device coupled to an accelerator device that includes a memory controller.

FIG. 6 illustrates generally an example of an accelerator device that includes a telemetry manager and a thermal manager.

FIG. 7A, FIG. 7B, and FIG. 7C illustrate generally respective examples of a CXL host device coupled to an accelerator device that includes a memory device.

FIG. 8 illustrates generally an example of a method for determining a device loading metric.

FIG. 9 illustrates generally an example of a method for using a device loading metric.

FIG. 10 illustrates a block diagram of an example machine with which, in which, or by which any one or more of the techniques discussed herein can be implemented.

### DETAILED DESCRIPTION

Compute Express Link (CXL) is an open standard interconnect configured for high-bandwidth, low-latency connectivity between host devices and other devices such as accelerators, memory buffers, and other I/O devices. CXL was designed to facilitate high-performance computational workloads by supporting heterogeneous processing and memory systems. CXL enables coherency and memory semantics on top of PCI Express (PCIe)-based I/O semantics for optimized performance.

In some examples, CXL is used in applications such as artificial intelligence, machine learning, analytics, cloud infrastructure, edge computing devices, communication systems, and elsewhere. Data processing in such applications can use various scalar, vector, matrix and spatial architectures that can be deployed in CPU, GPU, FPGA, smart NICs, or other accelerators that can be coupled using a CXL link.

CXL supports dynamic multiplexing using a set of protocols that includes input/output (CXL.io, based on PCIe), caching (CXL.cache), and memory (CXL.memory or CXL.mem) semantics. In an example, CXL can be used to maintain a unified, coherent memory space between the CPU (e.g., a host device or host processor) and any memory on the attached CXL device. This configuration allows the CPU and the CXL device to share resources and operate on the same memory region for higher performance, reduced data movement, and reduced software stack complexity. In an example, the CPU is primarily responsible for maintaining or managing coherency in a CXL environment. Accordingly, CXL can be leveraged to help reduce device cost and complexity, as well as overhead traditionally associated with coherency across an I/O link.

CXL runs on PCIe PHY and provides full interoperability with PCIe. In an example, a CXL device starts link training in a PCIe Gen 1 Data Rate and negotiates CXL as its operating protocol (e.g., using the alternate protocol negotiation mechanism defined in the PCIe 5.0 specification) if its link partner supports CXL. Devices and platforms can thus more readily adopt CXL by leveraging the PCIe infrastructure and without having to design and validate the PHY, channel, channel extension devices, or other upper layers of PCIc.

In an example, CXL supports single-level switching to enable fan-out to multiple devices. This enables multiple devices in a platform to migrate to CXL, while maintaining backward compatibility and the low-latency characteristics of CXL. In an example, CXL can provide a standardized compute fabric that supports pooling of multiple logical devices (MLD) and single logical devices such as using a CXL switch connected to several host devices or nodes (e.g., Root Ports). This feature enables servers to pool resources such as accelerators and/or memory that can be assigned according to workload. For example, CXL can help facilitate resource allocation or dedication and release. In an example, CXL can help allocate and deallocate memory to various host devices according to need. This flexibility helps designers avoid over-provisioning while ensuring best performance.

Some of the compute-intensive applications and operations mentioned herein can require or use large data sets. Memory devices that store such data sets can be configured for low latency and high bandwidth and persistence. One problem of a load-store interconnect architecture includes guaranteeing persistence. CXL can help address the problem using an architected flow and standard memory management interface for software, such as can enable movement of persistent memory from a controller-based approach to direct memory management.

The present inventors have recognized that a problem to be solved includes resource provisioning in systems that use CXL to coordinate operations among multiple devices, such as using one or multiple hosts, or one or multiple accelerators such as can include respective memory devices. In an example, the problem can include enhancing or optimizing telemetry in CXL systems. Telemetry generally includes automated, or semi-automated, communication of information among components in a system to help improve performance, security, or other system metrics. Telemetry information can be used to administer and manage the resources connected in the CXL system, and can include indications of under-provisioned (underutilized) and over-provisioned (overutilized) resources. In some examples, the telemetry information can include accelerator performance, utilization, temperature, or other information that can be used to characterize or quantify a behavior of an individual component or accelerator in the system.

In an example, telemetry information, or Quality of Service (QOS) telemetry information, can include information about each of multiple threads. For example, telemetry information can include information about which of multiple threads is accessing a particular resource (e.g., memory), or is using system bandwidth, or is occupying particular compute resources in the system.

The present inventors have recognized that the problem can include providing telemetry services in CXL-based systems. Such systems can include one or multiple media controllers (e.g., memory controllers), cache subsystems, or other accelerators. In an example, the problem can include providing queue-specific telemetry information in CXL-based systems that can include or use virtualization, such as using a multiple-logic device (MLD) or other virtual CXL switches or switch modules. The problem can include, for example, providing telemetry for memory transactions in virtualized or partially-virtualized CXL systems.

The present inventors have recognized that a solution to the telemetry problem can include or use resource reporting from each of multiple devices or queues in a CXL system. The solution can further include or use thermal status information to help provide information about loading of particular resources. The solution can optionally include providing resource usage or thermal status information for a request path, for a response path, or for request and response paths through the CXL system. In an example, the solution includes or uses a telemetry manager configured to track utilization or usage of queues, thermal status, and read-write response ratios in a particular accelerator coupled to a compute fabric, such as can include a CXL-based system. In an example, each accelerator (or each functional portion thereof) can be classified according to utilization, such as based on programmable threshold values that indicate different resource utilization levels. The levels can include, for example, light, optimal, moderate, and severe device utilization or loading levels. The levels or thresholds can be based on, for example, internal device queue utilization, read-write traffic ratios, or thermal characteristics, among other things. In an example, accelerator-specific resources can be monitored or measured at various locations, such as at an input to a CXL controller or at an output to a media controller (e.g., memory controller) in a particular accelerator device. In an example, the solution can include or use a respective telemetry manager for each classified resource range.

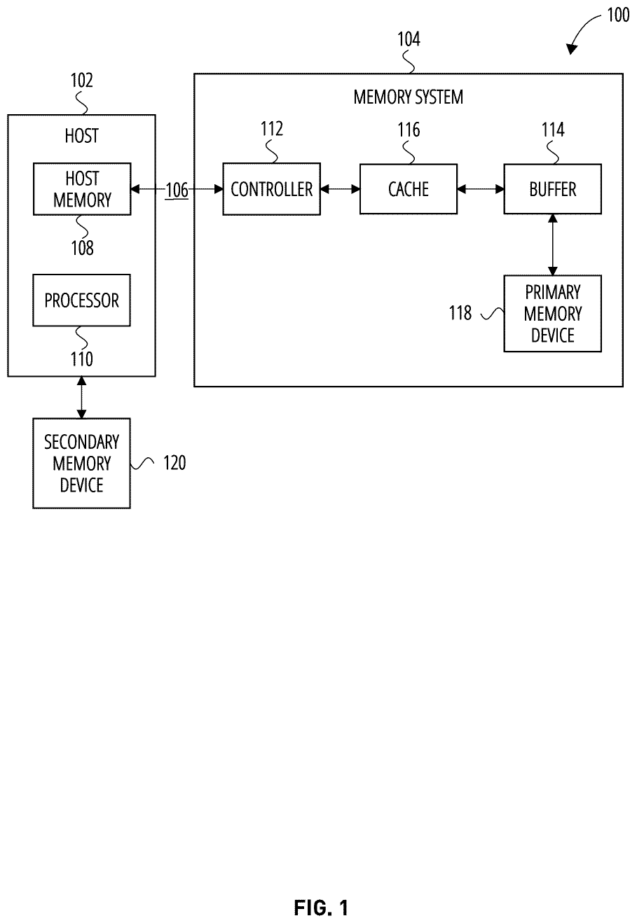

FIG. 1 illustrates generally a block diagram of an example of a computing system 100 including a host device 102 and a memory system 104. The host device 102 includes a central processing unit (CPU) or processor 110 and a host memory 108. In an example, the host device 102 can include a host system such as a personal computer, a desktop computer, a digital camera, a smart phone, a memory card reader, and/or Internet-of-things enabled device, among various other types of hosts, and can include a memory access device, e.g., the processor 110. The processor 110 can include one or more processor cores, a system of parallel processors, or other CPU arrangement.

The memory system 104 includes a controller 112, a buffer 114, a cache 116, and a first memory device 118. The first memory device 118 can include, for example, one or more memory modules (e.g., single in-line memory modules, dual in-line memory modules, etc.). The first memory device 118 can include volatile memory and/or non-volatile memory, and can include a multiple-chip device that comprises one or multiple different memory types or modules. In an example, the computing system 100 includes a second memory device 120 that interfaces with the memory system 104 and the host device 102.

The host device 102 can include a system backplane and can include a number of processing resources (e.g., one or more processors, microprocessors, or some other type of controlling circuitry). The computing system 100 can optionally include separate integrated circuits for the host device 102, the memory system 104, the controller 112, the buffer 114, the cache 116, the first memory device 118, the second memory device 120, any one or more of which may comprise respective chiplets that can be connected and used together. In an example, the computing system 100 includes a server system and/or a high-performance computing (HPC) system and/or a portion thereof. Although the example shown in FIG. 1 illustrates a system having a Von Neumann architecture, embodiments of the present disclosure can be implemented in non-Von Neumann architectures, which may not include one or more components (e.g., CPU, ALU, etc.) often associated with a Von Neumann architecture.

In an example, the first memory device 118 can provide a main memory for the computing system 100, or the first memory device 118 can comprise accessory memory or storage for use by the computing system 100. In an example, the first memory device 118 or the second memory device 120 includes one or more arrays of memory cells, e.g., volatile and/or non-volatile memory cells. The arrays can be flash arrays with a NAND architecture, for example. Embodiments are not limited to a particular type of memory device. For instance, the memory devices can include RAM, ROM, DRAM, SDRAM, PCRAM, RRAM, and flash memory, among others.

In embodiments in which the first memory device 118 includes persistent or non-volatile memory, the first memory device 118 can include a flash memory device such as a NAND or NOR flash memory device. The first memory device 118 can include other non-volatile memory devices such as non-volatile random-access memory devices (e.g., NVRAM, RcRAM, FeRAM, MRAM, PCM), memory devices such as a ferroelectric RAM device that includes ferroelectric capacitors that can exhibit hysteresis characteristics, a 3-D Crosspoint (3D XP) memory device, etc., or combinations thereof.

In an example, the controller 112 comprises a media controller such as a non-volatile memory express (NVMe) controller. The controller 112 can be configured to perform operations such as copy, write, read, error correct, etc. for the first memory device 118. In an example, the controller 112 can include purpose-built circuitry and/or instructions to perform various operations. That is, in some embodiments, the controller 112 can include circuitry and/or can be configured to perform instructions to control movement of data and/or addresses associated with data such as among the buffer 114, the cache 116, and/or the first memory device 118 or the second memory device 120.

In an example, at least one of the processor 110 and the controller 112 comprises a command manager (CM) for the memory system 104. The CM can receive, such as from the host device 102, a read command for a particular logic row address in the first memory device 118 or the second memory device 120. In some examples, the CM can determine that the logical row address is associated with a first row based at least in part on a pointer stored in a register of the controller 112. In an example, the CM can receive, from the host device 102, a write command for a logical row address, and the write command can be associated with second data. In some examples, the CM can be configured to issue, to non-volatile memory and between issuing the read command and the write command, an access command associated with the first memory device 118 or the second memory device 120. In some examples, the CM can issue, to the non-volatile memory and between issuing the read command and the write command, an access command associated with the first memory device 118 or the second memory device 120.

In an example, the buffer 114 comprises a data buffer circuit that includes a region of a physical memory used to temporarily store data, for example, while the data is moved from one place to another. The buffer 114 can include a first-in, first-out (FIFO) buffer in which the oldest (e.g., the first-in) data is processed first. In some embodiments, the buffer 114 includes a hardware shift register, a circular buffer, or a list.

In an example, the cache 116 comprises a region of a physical memory used to temporarily store particular data that is likely to be used again. The cache 116 can include a pool of data entries. In some examples, the cache 116 can be configured to operate according to a write-back policy in which data is written to the cache without being concurrently written to the first memory device 118. Accordingly, in some embodiments, data written to the cache 116 may not have a corresponding data entry in the first memory device 118.

In an example, the controller 112 can receive write requests (e.g., from the host device 102) involving the cache 116 and cause data associated with each of the write requests to be written to the cache 116. In some examples, the controller 112 can receive the write requests at a rate of thirty-two (32) gigatransfers (GT) per second, such as according to or using a CXL protocol. The controller 112 can similarly receive read requests and cause data stored in, e.g., the first memory device 118 or the second memory device 120, to be retrieved and written to, for example, the host device 102 via an interface 106.

In an example, the interface 106 can include any type of communication path, bus, or the like that allows information to be transferred between the host device 102 and the memory system 104. Non-limiting examples of interfaces can include a peripheral component interconnect (PCI) interface, a peripheral component interconnect express (PCIe) interface, a serial advanced technology attachment (SATA) interface, and/or a miniature serial advanced technology attachment (mSATA) interface, among others. In an example, the interface 106 includes a PCIe 5.0 interface that is compliant with the compute express link (CXL) protocol standard. Accordingly, in some embodiments, the interface 106 supports transfer speeds of at least 32 GT/s.

As similarly described elsewhere herein, CXL is a high-speed central processing unit (CPU)-to-device or CPU-to-memory interconnect designed to enhance compute performance. CXL technology maintains memory coherency between a CPU memory space (e.g., the host memory 108) and memory on attached devices or accelerators (e.g., the first memory device 118 or the second memory device 120), which allows resource sharing for higher performance, reduced software stack complexity, and lower overall system cost. CXL is designed to be an industry open standard interface for high-speed communications as accelerators are increasingly used to complement CPUs in support of emerging data-rich and compute-intensive applications such as artificial intelligence and machine learning.

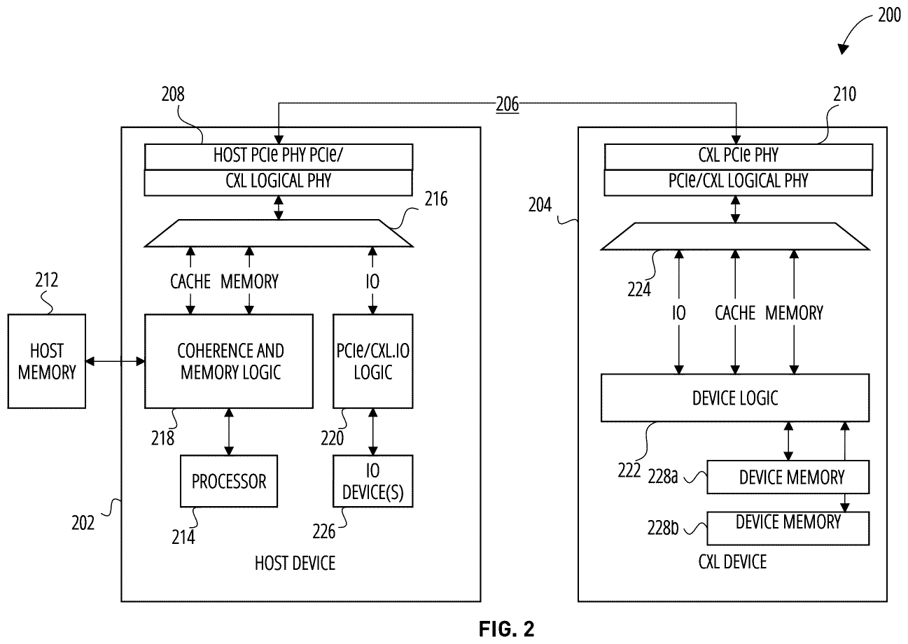

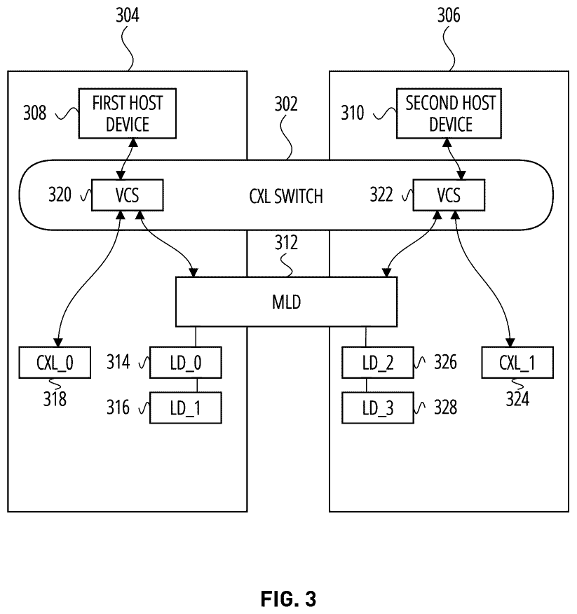

FIG. 2 illustrates generally an example of a CXL system 200 that uses a CXL link 206 to connect a host device 202 and a CXL device 204. In an example, the host device 202 comprises or corresponds to the host device 102 and the CXL device 204 comprises or corresponds to the memory system 104 from the example of the computing system 100 in FIG. 1. A memory system command manager (CM) can comprise a portion of the host device 202 or the CXL device 204. In an example, the CXL link 206 (e.g., corresponding to the interface 106 from the example of FIG. 1) can support communications using multiplexed protocols for caching (e.g., CXL.cache), memory accesses (e.g., CXL.mem or CXL.memory), and data input/output transactions (e.g., CXL.io). CXL.io can include a protocol based on PCIe that is used for functions such as device discovery, configuration, initialization, I/O virtualization, and direct memory access (DMA) using non-coherent load-store, producer-consumer semantics. CXL.cache can enable a device to cache data from the host memory (e.g., from the host memory 212) using a request and response protocol. CXL.memory can enable the host device 202 to use memory attached to the CXL device 204, for example, in or using a virtualized memory space. The CXL-based memory device can include or use a volatile or non-volatile memory such as can be characterized by different speeds or latencies. In an example, the CXL-based memory device can include a CXL-based memory controller configured to manage transactions with the volatile or non-volatile memory.

In an example, CXL.memory transactions can be memory load and store operations that run downstream from or outside of the host device 202. CXL memory devices can have different levels of complexity. For example, a simple CXL memory system can include a CXL device that includes, or is coupled to, a single media controller, such as a memory controller (MEMC). A moderate CXL memory system can include a CXL device that includes, or is coupled to, multiple media controllers. A complex CXL memory system can include a CXL device that includes, or is coupled to, a cache controller (and its attendant cache) and to one or more media or memory controllers.

In the example of FIG. 2, the host device 202 includes a host processor 214 (e.g., comprising one or more CPUs or cores) and IO device(s) 226. The host device 202 can comprise, or can be coupled to, host memory 212. The host device 202 can include various circuitry or logic configured to facilitate CXL-based communications and transactions with the CXL device 204. For example, the host device 202 can include coherence and memory logic 218 configured to implement transactions according to CXL.cache and CXL.memory semantics, and the host device 202 can include PCIe logic 220 configured to implement transactions according to CXL.io semantics. In an example, the host device 202 can be configured to manage coherency of data cached at the CXL device 204 using, e.g., its coherence and memory logic 218.

The host device 202 can further include a host multiplexer 216 configured to modulate communications over the CXL link 206 (e.g., using the PCIe PHY layer). The multiplexing of protocols ensures that latency-sensitive protocols (e.g., CXL.cache and CXL.memory) have the same or similar latency as a native processor-to-processor link. In an example, CXL defines an upper bound on response times for latency-sensitive protocols to help ensure that device performance is not adversely impacted by variation in latency between different devices implementing coherency and memory semantics.

In an example, symmetric cache coherency protocols can be difficult to implement between host processors because different architectures may use different solutions, which in turn can compromise backward compatibility. CXL can address this problem by consolidating the coherency function at the host device 202, such as using the coherence and memory logic 218.

The CXL device 204 can include an accelerator device that comprises various accelerator logic 222. In an example, the CXL device 204 can comprise a device memory 228a, or can be coupled to a CXL device memory 228b. The CXL device 204 can include various circuitry or logic configured to facilitate CXL-based communications and transactions with the host device 202 using the CXL link 206. For example, the accelerator logic 222 can be configured to implement transactions according to CXL.cache, CXL.memory, and CXL.io semantics. The CXL device 204 can include a CXL device multiplexer 224 configured to control communications over the CXL link 206.

In an example, one or more of the coherence and memory logic 218 and the accelerator logic 222 comprises a Unified Assist Engine (UAE) or compute fabric with various functional units such as a command manager (CM), Threading Engine (TE), Streaming Engine (SE), Data Manager or data mover (DM), or other unit. The compute fabric can be reconfigurable and can include separate synchronous and asynchronous flows.

The accelerator logic 222 or portions thereof can be configured to operate in an application space of the CXL system 200 and, in some examples, can initiate its own threads or sub-threads, which can operate in parallel and can optionally use resources or units on other CXL devices 204. Queue and transaction control through the system can be coordinated by the CM, TE, SE, or DM components of the UAE. In an example, each queue or thread can map to a different loop iteration to thereby support multi-dimensional loops. With the capability to initiate such nested loops, among other capabilities, the system can realize significant time savings and latency improvements for compute-intensive operations.

In an example, command fencing can be used to help maintain order throughout such operations, which can be performed locally or throughout a compute space of the accelerator logic 222. In some examples, the CM can be used to route commands to a particular command execution unit (e.g., comprising the accelerator logic 222 of a particular instance of the CXL device 204) using an unordered interconnect that provides respective transaction identifiers (TID) to command and response message pairs.

In an example, the CM can coordinate a synchronous flow, such as using an asynchronous fabric of the reconfigurable compute fabric to communicate with other synchronous flows and/or other components of the reconfigurable compute fabric using asynchronous messages. For example, the CM can receive an asynchronous message from a dispatch interface and/or from another flow controller instructing a new thread at or using a synchronous flow. The dispatch interface may interface between the reconfigurable compute fabric and other system components. In some examples, a synchronous flow may send an asynchronous message to the dispatch interface to indicate completion of a thread.

Asynchronous messages can be used by synchronous flows such as to access memory. For example, the reconfigurable compute fabric can include one or more memory interfaces. Memory interfaces are hardware components that can be used by a synchronous flow or components thereof to access an external memory that is not part of the synchronous flow but is accessible to the host device 202 or the CXL device 204. A thread executed using a synchronous flow can include sending a read and/or write request to a memory interface. Because reads and writes are asynchronous, the thread that initiates a read or write request to the memory interface may not receive the results of the request. Instead, the results of a read or write request can be provided to a different thread executed at a different synchronous flow. Delay and output registers in one or more of the CXL devices 204 can help coordinate and maximize efficiency of a first flow, for example, by precisely timing engagement of particular compute resources of one device with arrival of data relevant to the first flow. The registers can help enable the particular compute resources of the same resource to be repurposed for flows other than the first flow, for example while the first flow dwells or waits for other data or operations to complete. Such other data or operations can depend on one or more other resources of the fabric.

In an example, the CXL device 204 includes a memory device configured to use quality of service (QOS) telemetry to report its load or occupation status to the host device 202 or to other devices or managers in the CXL system 200. In an example, each CXL device 204 reports its load status to its respective host in each CXL.mem response. The host device 202 can receive the load status information from the CXL device 204 and from one or more other CXL devices 204 in the CXL system 200 and use the information together to help control traffic in the CXL system 200 and avoid underutilizing (e.g., under-compensating, or under-provisioning) or overutilizing (e.g., over-compensating or over-provisioning) resources in the system. The host device 202 can be configured to dynamically adjust its request handling, in response to the load status information from one or more CXL devices 204, to help optimize system performance.

In an example, each CXL device 204 can be configured to determine its load status (sometimes referred to as device load, or DevLoad) based on internal resource utilization metrics or internal queuing, such as in one or more device subsystems. A metric for analyzing utilization can include a continuous spectrum of quantitative DevLoad characteristics. In an example, another metric for analyzing utilization can include or use classes or groups of device usage, such as can be based on different specified threshold amounts or quantities of particular DevLoad characteristics. For example, a minimum or “light” DevLoad can correspond to minimal queuing delay inside the CXL device 204 and, accordingly, the CXL device 204 can indicate underutilization and availability to accept additional transactions or requests from the host device 202. An “optimal” DevLoad can correspond to modest or moderate queuing delay inside the CXL device 204 and, accordingly, the CXL device 204 can indicate to the host device 202 that it is optimally utilized. A “moderate” DevLoad can correspond to significant queuing delay inside the CXL device 204 and, accordingly, the CXL device 204 can indicate to the host device 202 that the resources on the CXL device 204 are over-provisioned, and that additional requests will be queued or delayed. A “severe” DevLoad can correspond to a highest queuing delay inside the CXL device 204 and, accordingly, the CXL device 204 can indicate to the host device 202 that the resources on the CXL device 204 are heavily over-provisioned and that additional requests will be queued and significantly delayed. Other classes or groups can be similarly defined with various intermediate or overlapping levels of device usage or DevLoad granularity.

Some telemetry systems can be configured to track memory resource queuing, such as within a particular CXL device 204, to determine a DevLoad characteristic for a particular device. The present inventors have recognized that in some systems, such as can include or use virtualized memory space in a CXL system, various device-internal queues and/or read-write traffic ratios can be monitored and used to help optimize resource provisioning and, accordingly, improve system performance.

FIG. 3 illustrates generally an example of a portion of a CXL system that can include or use a virtual hierarchy for managing transactions, such as memory transactions with a CXL memory device. The example can include or use real-time telemetry to help facilitate allocation of new or ongoing queues. The example of FIG. 3 includes a first virtual hierarchy 304 and a second virtual hierarchy 306. The first virtual hierarchy 304, the second virtual hierarchy 306, or one or more modules or components thereof can be implemented using the host device 202, the CXL device 204, or multiple instances of the host device 202 or the CXL device 204.

In the example of FIG. 3, the first virtual hierarchy 304 includes a first host device 308 and the second virtual hierarchy 306 includes a second host device 310. A CXL switch 302 can be provided to expose multiple CXL resources to different hosts in the system. In other words, the CXL switch 302 can be configured to couple each of the first host device 308 and the second host device 310 to the same or different resources, such as using respective virtual CXL switches (VCS), such as a first VCS 320 and a second VCS 322, respectively. The CXL switch 302 can be statically configured to couple each host device to respective different resources or the CXL switch 302 can be dynamically configured to the different resources, such as depending on the needs of a particular one of the host devices to execute its respective queues or threads. Accordingly, the CXL switch 302 enables virtual hierarchies and resource sharing among different hosts.

In an example, a fabric manager (FM) can be provided to assign or coordinate connectivity of the CXL switch 302 and can be configured to initiate, dissolve, or reconfigure the virtual hierarchies of the CXL system. The FM can include a baseboard management controller (BMC), an external controller, a centralized controller, or other controller.

In the example of FIG. 3, the CXL switch 302, or the first VCS 320 or the second VCS 322, can coordinate communication between the host devices and various accelerators. For example, the CXL switch 302 can be coupled to various CXL devices (e.g., a first CXL device 318 or a second CXL device 324), or to various logical devices, such as a single logical device (LD, e.g., a first LD 314, a second LD 316, a third LD 326, or a fourth LD 328) via a multiple logic device (MLD, e.g., a MLD 312). Each CXL device and logical device can represent a respective accelerator or CXL device with its own respective CXL.io configuration space, CXL.mem memory space, and CXL.cache cache space.

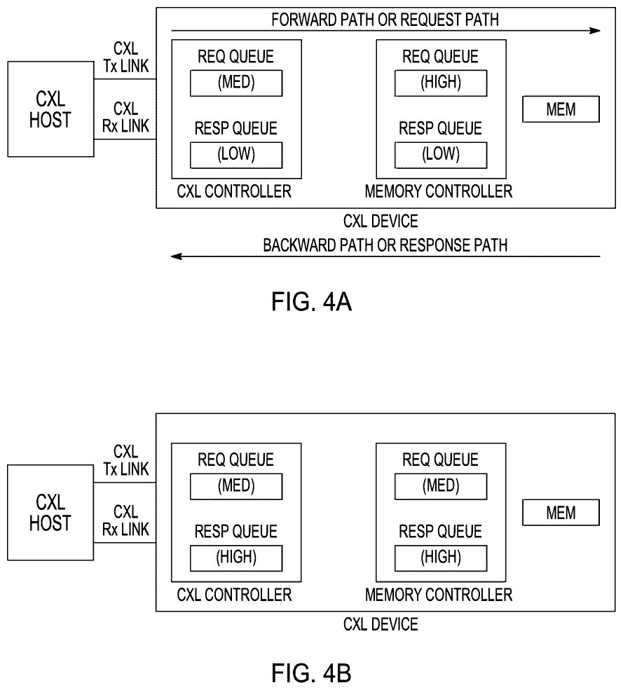

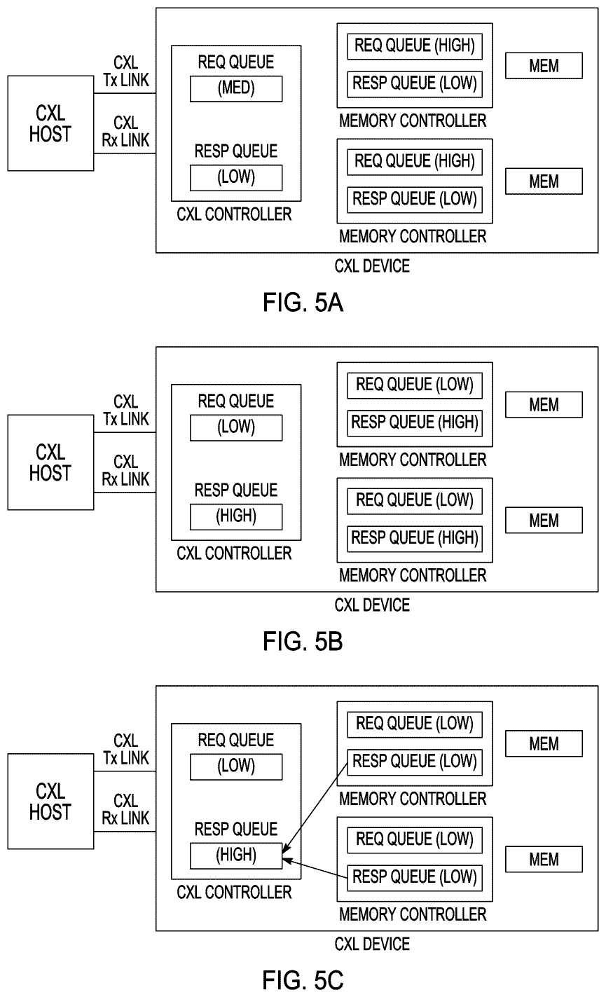

FIG. 4A, FIG. 4B, FIG. 5A, FIG. 5B, and FIG. 5C illustrate generally respective examples of a CXL host device (e.g., the host device 202) coupled to an accelerator device (e.g., the CXL device 204), such as can include a memory device. In an example, the accelerator device includes a CXL controller that manages transactions with the host and the accelerator includes a memory controller that manages transactions with a memory (MEM). The memory can include or use a volatile memory such as DRAM, SDRAM, PCRAM, RRAM, among other kinds of memory. The memory can additionally or alternatively include or use non-volatile memory, such as NAND or NOR flash memory. Although the host and accelerator devices are discussed in various examples herein as a “CXL” host device and a “CXL” accelerator or “CXL” device, other types of hosts and accelerators can similarly be used without including or using CXL protocols.

FIG. 4A illustrates generally an example of an accelerator device with a single backend media controller or memory controller. The memory controller can include or use a relatively slow memory in terms of, for example, access or data transfer rate (e.g., DRAM). In the example of FIG. 4A, a queuing delay on the accelerator device can occur due to request path overutilization or overloading. For example, a forward path or request path in the accelerator device can get overloaded when requests arrive more quickly than they can be serviced by the backend media or memory (MEM). That is, the CXL controller and the memory controller on the accelerator device can have a request queue utilization that is high.

In the example of FIG. 4A, a backward path or response path can be underutilized or relatively lightly loaded. That is, the CXL controller and the memory controller on the accelerator device can have a response queue utilization that is low. In an example, the CXL host device can be configured to help mitigate the queuing delay by monitoring a request queue of the memory controller on the accelerator device and assigning new queues to other resources when the memory controller is overutilized.

FIG. 4B illustrates generally an example of an accelerator device that includes or uses a relatively fast memory in terms of, for example, access or data transfer rate (e.g., SRAM). In the example of FIG. 4B, a queuing delay on the accelerator device can occur due to response path overutilization or overloading. For example, a forward path or request path in the accelerator device can be lightly loaded because the backend media or memory (MEM) can service requests relatively quickly and as they arrive from the CXL controller. Accordingly, the request queue of the memory controller can be underutilized.

In the example of FIG. 4B, a backward path or response path can be overutilized due to the relatively fast backend media. Accordingly, the CXL controller and the memory controller on the accelerator device can have a response queue utilization that is high. In an example, the CXL host device can be configured to help mitigate the response queue overutilization by monitoring a response queue at the CXL controller and assigning new queues to other resources when the response queue at the CXL controller is overutilized.

FIG. 5A, FIG. 5B, and FIG. 5C illustrate generally an example of an accelerator device with multiple backend media controllers or memory controllers. In the example of FIG. 5A, the accelerator memory controllers can include or use relatively slow memory devices in terms of, for example, access or data transfer rate (e.g., DRAM). In the example of FIG. 5A, a queuing delay on the accelerator device can occur due to request path overutilization or overloading, such as for one or more of the memory controllers. For example, a forward path or request path in the accelerator device can get overloaded when requests arrive at one or more of the memory controllers more quickly than they can be serviced by the respective backend media or memory devices (MEM). That is, the CXL controller and the memory controllers on the accelerator device can have a request queue utilization that is high.

In the example of FIG. 5A, a backward path or response path can be underutilized or relatively lightly loaded. That is, the CXL controller and the memory controllers on the accelerator device can have a response queue utilization that is low. In an example, the CXL host device can be configured to help mitigate the queuing delay by monitoring request queues of each of the memory controllers on the accelerator device and assigning new queues to other resources when one or more of the memory controllers is overutilized.

FIG. 5B illustrates generally an example of an accelerator device that includes multiple memory controllers configured to use respective relatively fast memory in terms of, for example, access or data transfer rate (e.g., SRAM). In the example of FIG. 5B, a queuing delay on the accelerator device can occur due to response path overutilization or overloading, such as in one or more of the memory controllers. For example, a forward path or request path in the accelerator device can be lightly loaded because the backend media or memory (MEM) can service requests relatively quickly and as they arrive from the CXL controller. Accordingly, the request queues of the respective memory controllers can be underutilized.

In the example of FIG. 5B, a backward path or response path through one or more of the memory controllers can be overutilized due to the relatively fast backend media.

Accordingly, the CXL controller and the memory controllers on the accelerator device can have a response queue utilization that is high. In an example, the CXL host device can be configured to help mitigate the response queue overutilization by monitoring a response queue at the CXL controller and assigning new queues to other resources when the response queue at the CXL controller is overutilized.

FIG. 5C illustrates generally an example of an accelerator device that includes multiple memory controllers configured to use respective memory devices that can have the same or different speed characteristics. In the example of FIG. 5C, responses from each of two or more of the memory controllers on the accelerator device can collide or converge on a particular CXL response queue at the CXL controller. In this example, response queues at each of the individual memory controllers may be unsaturated, however, the CXL controller can become oversubscribed when multiple memory controllers push response messages to the CXL controller.

In an example, the CXL host device can be configured to help mitigate the response queue overutilization by monitoring response queue activity at the CXL controller and at each of the memory controllers. For example, it may be insufficient to monitor memory controller queue utilization alone when multiple memory controllers can provide responses to the same CXL controller.

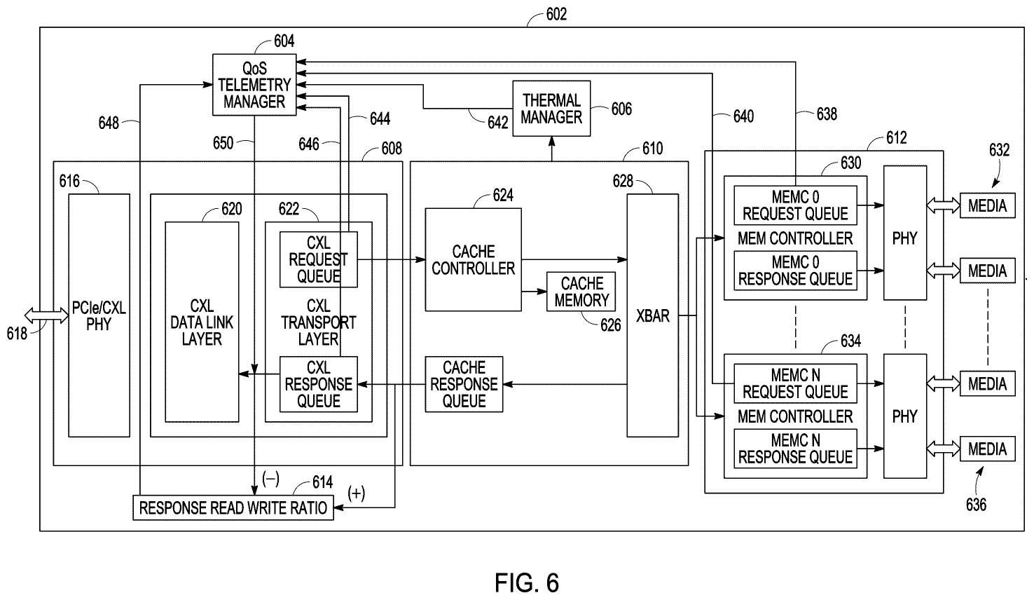

FIG. 6 illustrates generally an example of an accelerator device 602 that includes a telemetry manager 604 and a thermal manager 606. In an example, the accelerator device 602 is a CXL accelerator device configured to communicate with one or more hosts via a CXL interface, such as using transactions defined by CXL.io, CXL.mem, and CXL.cache protocols. The accelerator device 602 can include a memory device that includes one or multiple memories, such as can include memories of the same type or of different types. In an example, the thermal manager 606 can receive thermal characteristic information from one or multiple portions of the accelerator device 602. In an example, the telemetry manager 604 is configured to receive performance metric information, or DevLoad information, from various components of, or components coupled to, the accelerator device 602, and the telemetry manager 604 can be configured to receive thermal characteristic information from the thermal manager 606. The telemetry manager 604 can be configured to report DevLoad information about the accelerator device 602, or about components thereof, to one or more host devices. In an example, the telemetry manager 604 can be configured to calculate or determine a DevLoad-indicating metric about the accelerator device 602 (or about one or more components thereof) based on request and/or response path utilization and based on thermal characteristic from one or more portions of the accelerator device 602.

For case of illustration and discussion, the example of the accelerator device 602 includes a notional front end portion 608, a middle end portion 610, and a back end portion 612. The portions and components thereof of the accelerator device 602 can be differently configured or combined according to different implementations of the accelerator device 602.

In the example of FIG. 6, the front end portion 608 can include a CXL link 618 configured to use a CXL PCIe PHY layer 616 to interface with a host device. The front end portion 608 can further include a CXL data link layer 620 and a CXL transport layer 622 configured to manage transactions between the accelerator device 602 and the host. In an example, the CXL transport layer 622 comprises registers and operators configured to manage CXL request queues (e.g., comprising one or more memory transaction requests) and CXL response queues (e.g., comprising one or more memory transaction responses) for the accelerator device 602. In an example, the front end portion 608 includes a read-write manager 614. The read-write manager 614 can be configured to monitor read and write transactions and transaction status information inside the accelerator device 602. For example, the read-write manager 614 can be configured to report a read/write ratio to the telemetry manager 604 as an indicator of DevLoad for the accelerator device 602. In an example, the read-write manager 614 provides the ratio information using a read-write signal 648, such as can include a metric with information about reads, writes, or both reads and writes.

In an example, the accelerator device 602 can include a memory device that includes a cache (e.g., comprising SRAM) and includes longer-term volatile or non-volatile memory accessible via a memory controller. In the example of FIG. 6, the accelerator device 602 includes a cache memory 626 in the middle end portion 610 of the device. The middle end portion 610 can include a cache controller 624 configured to monitor requests from the CXL transport layer 622 and identify requests that can be fulfilled using the cache memory 626.

Various complexities can arise in CXL systems. For example, CXL transactions can be based on a relatively large transaction size (e.g., 64 bytes), while some processes may use more granularity or smaller data sizes. Accordingly, in some examples, the cache controller 624 can be included or used in the accelerator device 602 to store excess data fetched from backend media controllers or memories, such as from one or more memories in the back end portion 612 of the accelerator device 602.

In an example, the cache controller 624 is coupled to a cross-bar interface or XBAR interface 628. The XBAR interface 628 can be configured to allow multiple requesters to access multiple memory controllers in parallel, such as including multiple memory controllers in the back end portion 612 of the accelerator device 602. In an example, the XBAR interface 628 provides essentially point-to-point access between the requestor and memory controller and provides generally higher performance than would be available using a conventional bus architecture. The XBAR interface 628 can be configured to receive responses from the back end portion 612 or receive cache hits from the cache memory 626 and deliver the responses to the front end portion 608 using a cache response queue.

In the example of FIG. 6, the back end portion 612 of the accelerator device 602 includes multiple memory controllers, including a first memory controller 630 through an Nth memory controller 634. Each of the memory controllers can have or use respective memory request and response queues. Each of the memory controllers can be coupled to respective media or memories, such as can comprise volatile or non-volatile memory. In the illustrated example, the first memory controller 630 is coupled to a first memory 632 and the Nth memory controller 634 is coupled to an Nth memory 636.

In an example, each of the multiple memory controllers in the system can manage its own respective queues. In some examples, different memory controllers can be configured to use or interface with different memories such as can have different latency characteristics. Accordingly, performance optimization can include coordination of the respective queues of each memory controller. Informed coordination can be based on, for example, request and response path information for each memory controller.

In an example, a solution to the resource allocation problem described herein for distributed CXL devices or other accelerators can include identifying the queues that contribute to, or could contribute to, a bottleneck or restriction in the function of some portion of the system. In an example, the queues can correspond to different kinds of accelerators, different types of CXL devices, such as can have different device topologies. Each or multiple CXL devices in a system can be configured to provide a Dev Load-indicating signal to the system host, or hosts. In response, the host or hosts can use the DevLoad-indicating signal or signals to help optimize queue generation across multiple devices, such as based on resource utilization on the accelerators available to the host.

In the example of FIG. 6, the accelerator device 602 includes the telemetry manager 604 that is configured to receive performance or DevLoad metric information from various components of the accelerator device 602 and provide a DevLoad-indicating signal 650 for the accelerator device 602. The DevLoad-indicating signal 650 can be provided to a host, fabric manager, or other controller in a system in which the accelerator device 602 is used. In response to the DevLoad-indicating signal 650, the host, fabric manager, or other controller can determine which accelerator devices 602 in the system are underutilized or overutilized. For example, based on the DevLoad-indicating signal 650, a host can assign new queues or threads to underutilized resources or can dynamically adjust virtualized memory spaces to maximize efficiency and minimize latency.

In an example, the telemetry manager 604 can be configured to use request queue utilization information from each of the memory controllers in the back end portion 612 of the accelerator device 602 to determine the DevLoad-indicating signal 650. For example, the telemetry manager 604 can receive a first memory controller request queue utilization signal 638 with information about a utilization characteristic of a request queue for the first memory controller 630, and the telemetry manager 604 can receive a second memory controller request queue utilization signal 640 with information about a utilization characteristic of a request queue for the Nth memory controller 634. The memory controller request queue utilization signals include information about occupancy within each respective memory controller. In an example, if the request queue occupancy of a particular memory controller exceeds a predetermined occupancy threshold, then the memory or media associated with the particular memory controller can be a bottleneck that may be causing request queues to be overutilized. In response to such overutilization, a host can throttle requests sent to the particular memory controller or sent to the particular CXL device that includes the particular memory controller.

The telemetry manager 604 can be configured to use accelerator-level request or response queue utilization information, such as from the front end portion 608, to determine the DevLoad-indicating signal 650. For example, the telemetry manager 604 can receive a CXL request queue utilization signal 644 that includes information about a volume or quantity of requests that are received by the accelerator device 602 (e.g., via CXL.mem) and that are sent or are pending at the middle end portion 610, the back end portion 612, or at other portions of the accelerator device 602. In an example, the telemetry manager 604 can receive a CXL response queue utilization signal 646 that includes information about a volume or quantity of responses that are received or are pending at the middle end portion 610, the back end portion 612, or at other portions of the accelerator device 602.

In an example, information from the CXL request queue utilization signal 644 can be used to optimize topologies that include or use a central cache controller, such as the cache controller 624, such as where the middle end portion 610 can become a bottleneck. In such cases, the memory controller utilization signals may not reveal information about the device forward path being overutilized. In an example, if the CXL request queue utilization signal 644 indicates high occupancy but the memory controller request queue utilization signals indicate low occupancy, then it can be determined that the subsystem in the middle end portion 610 of the accelerator device 602 (e.g., the cache controller 624 and associated components) is a performance bottleneck.

In an example, information from the CXL response queue utilization signal 646 can be used to track queue occupancy within the CXL controller. If the CXL response queue utilization signal 646 indicates queue occupancy is greater than a specified threshold amount, then it can be determined that the response link is overutilized. In other words, it can be determined that the media or memory in the back end portion 612 are sufficiently fast to fulfill requests but the CXL response link is a performance bottleneck.

The telemetry manager 604 can be configured to receive a thermal status signal 642 from the thermal manager 606. The thermal status signal 642 can include one or multiple signals that indicate respective thermal characteristics of portions of the accelerator device 602. In an example, the thermal status signal 642 is a composite or combined signal indicative of a temperature characteristic of the accelerator device 602, such as can include an average of multiple temperatures of respective different portions of the device. In an example, the thermal status signal 642 includes a binary signal that indicates whether a thermal characteristic or temperature of any of the subsystems or portions of the accelerator device 602 exceeds a specified threshold thermal condition. In some examples, information about particular thermal characteristics of the accelerator device 602 in the thermal status signal 642 can be used by the telemetry manager 604 to indicate an immediate response, such as irrespective of the queue utilization information received by the telemetry manager 604. For example, if a portion of the accelerator device 602 is indicated to be overheated, then the DevLoad for the device can be immediately throttled or changed regardless of the queue utilization status.

The telemetry manager 604 can be configured to receive a read-write signal 648 from the read-write manager 614. The read-write signal 648 can include a metric with information about reads, writes, or both reads and writes (e.g., expressed as a ratio) performed by or queued for use or transmission by the accelerator device 602, such as within or over a specified time duration. For example, the read-write signal 648 can include information about the relative amounts of read information and write information included in CXL messages transmitted using the CXL link 618. The CXL messages can include, for example, 64 byte flow control units or FLITs, such as comprising multiple slots (e.g., 4 slots of 16 bytes each), or 256 byte FLITs, etc. In an example, write responses (e.g., non-data responses or NDR) can be efficiently packaged in a 64 byte CXL message or response FLIT (e.g., 1 slot can carry 3 write responses), whereas data for a particular read responses (DRS) can occupy multiple slots, such as in one or multiple FLITs. As one example, 2 read responses can consume 9 slots, such as can use 3 FLITs communicated using the CXL link 618. Accordingly, if the CXL response queue includes a relatively large number of write responses (e.g., greater than a specified threshold number of write responses), then the responses can be sent out using the CXL link 618 relatively efficiently and quickly using a low number of FLITs. On the other hand, read responses can occupy more space and, accordingly, can take longer to communicate or can use more FLITs. Therefore, it can be important to track the type of information (e.g., as write responses vs. read responses) in the CXL response queue to inform how quickly the CXL response queue can be cleared.

In an example, the telemetry manager 604 can use the various input signals described above to determine the DevLoad-indicating signal 650. For example, the telemetry manager 604 can decode one or more of the first memory controller request queue utilization signal 638, the second memory controller request queue utilization signal 640, the thermal status signal 642, the CXL request queue utilization signal 644, the CXL response queue utilization signal 646, and the read-write signal 648 and determine a utilization state of the accelerator device 602, or of a portion of the accelerator device 602, that can be reported to a host. In an example, the accelerator device 602 can report utilization state information from the telemetry manager 604 with each response message sent to the host via the CXL link 618. In response, the host can optionally update or change a rate of traffic for the accelerator device 602. The host-based traffic rate adjustment can be host-specific or application-specific.

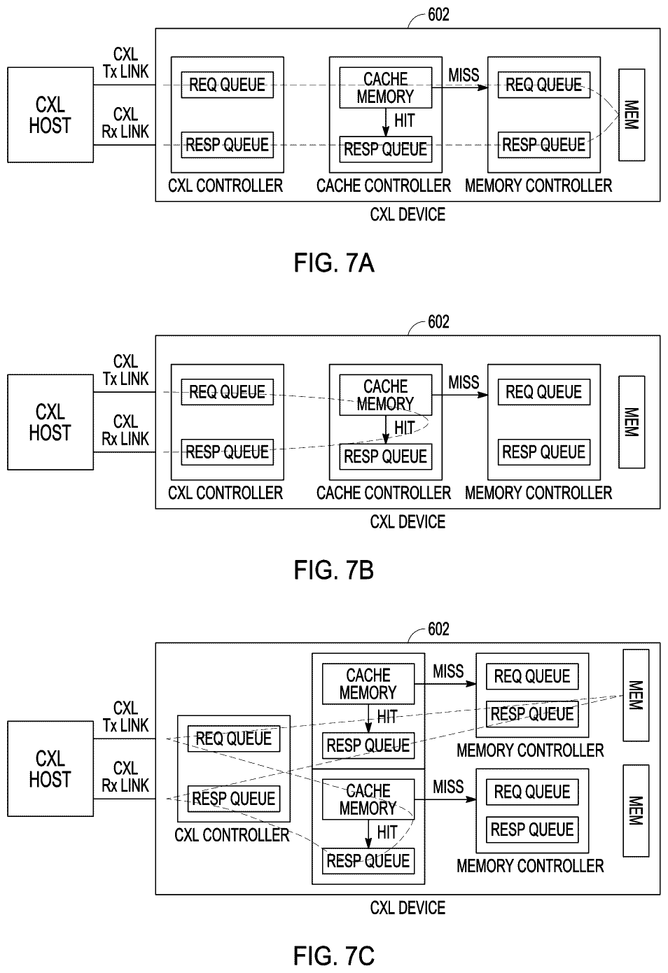

FIG. 7A, FIG. 7B, and FIG. 7C illustrate generally respective examples of a CXL host device (e.g., the host device 202) coupled to the accelerator device 602, such as can include or use a memory device configured to use CXL. The accelerator device 602 can include, for example, a CXL controller portion (e.g., corresponding to the front end portion 608 of the accelerator device 602), the cache controller 624 (e.g., corresponding to the middle end portion 610 of the accelerator device 602), and a memory controller portion (e.g., corresponding to the back end portion 612 of the accelerator device 602). Accordingly, an example of the accelerator device 602 can include a CXL device with a central cache controller and one or more backend media or memory controllers.

In the example of FIG. 7A, the cache controller can have a relatively low cache hit rate, and a majority of requests can be sent through the device to the memory controller. In this example, the memory controller request queue can have a relatively high utilization as compared to the response queue. Utilization or DevLoad of the accelerator device 602 can be monitored using, for example, memory controller request queue signals, such as the first memory controller request queue utilization signal 638, the second memory controller request queue utilization signal 640, and so on, depending on the number of memory controllers used in the accelerator device 602.

In the example of FIG. 7B, the cache controller can have a relatively high hit rate, and a majority of requests can be serviced by the cache in the middle end portion 610 of the accelerator device 602. In other words, relatively few requests may need to be serviced by the backend media or memory controller(s). In this example, the CXL response path may be overutilized due to the relatively high speed and hit rate at the cache controller. If a load of new requests on the ingress port of the accelerator device 602 increases, then utilization of the memory controller response and request queues can remain relatively low as long as the cache hit level is maintained. If, however, the cache controller is slow, it can throttle the CXL request queue, and the CXL request queue utilization signal 644 can indicate overutilization. In this example, utilization or DevLoad of the accelerator device 602 can be monitored using, for example, the CXL request queue utilization signal 644 and the CXL response queue utilization signal 646.

In the example of FIG. 7C, the accelerator device 602 can include or use multiple cache controllers. Similarly to the example of FIG. 5C, responses from the cache controllers can potentially collide or converge on a particular CXL response queue at the CXL controller. In this example, response queues at each of the individual memory controllers or cache controllers may be unsaturated, however, the CXL controller can become oversubscribed when multiple cache controllers push response messages to the CXL controller. In an example, even when one of the cache controllers has a high hit rate and the other cache controller has a low hit rate, the cache responses can converge on the CXL response queue and cause a bottleneck. In this example, utilization or DevLoad of the accelerator device 602 can be monitored using, for example, the CXL response queue utilization signal 646 and one or more of the first memory controller request queue utilization signal 638, the second memory controller request queue utilization signal 640, or other memory controller request queue utilization signals.

FIG. 7A, FIG. 7B, and FIG. 7C represent some examples of device loading that can occur at an accelerator CXL device. To help mitigate loading and optimize efficiency, the accelerator device 602 can provide the DevLoad-indicating signal 650 to the host and the host can determine which mitigation measures to take. Multiple accelerator device-internal resources can be tracked and monitored for utilization and can be analyzed together to provide the DevLoad-indicating signal 650.

According to various examples, the DevLoad-indicating signal 650 can indicate a classification or association of the accelerator device 602 with respect to different levels of device resource loading or occupation, such as a light loading (e.g., corresponding to low loading, or underutilization of at least a portion of the device), optimal loading, moderate loading, and severe loading (e.g., corresponding to high loading, or overutilization of at least a portion of the device). Such stratification of device occupancy or loading may, in some examples, correspond to standardized classifications under a CXL specification. Different request and response utilization signals can correspond to different DevLoad classification-indicating information in the DevLoad-indicating signal 650. The following tables provide some examples of relationships between information in the DevLoad-indicating signal 650 and various request and response queue levels.

TABLE 1
DevLoad-indicating signal 650 information when a memory controller
request queue utilization signal indicates light utilization.

| CXL | | CXL | | |
|---|---|---|---|---|
| response | | request | | |
| queue | | queue | | DevLoad- |
| utilization | read-write | utilization | | indicating |
| signal 646 | signal 648 | signal 644 | | signal 650 |
| information | information | information | Comment | information |
| Light | N/A | N/A | Device traffic | Light |
| | | | is sparse | |
| Optimal | Write heavy | N/A | Backend media | Light |
| | | | may generate | |
| | | | responses | |
| | | | quickly; cache | |
| | | | controller may | |
| | | | have high hit | |
| | | | rate (low | |
| | | | MEMC usage); | |
| | | | multiple | |
| | | | MEMC may | |
| | | | use CXL | |
| | | | response queue | |
| Optimal | Read heavy | N/A | Traffic from | Optimal |
| | | | host device | |
| | | | may be high; | |
| | | | CXL response | |
| | | | queue may be | |
| | | | overutilized | |
| Moderate | Write heavy | N/A | | Optimal |
| Moderate | Read heavy | N/A | | Moderate |
| High | N/A | Light or | Request path | Moderate |
| | | optimal | may be | |
| | | | available but | |
| | | | response path | |
| | | | is overutilized; | |
| | | | light device | |
| | | | throttling may | |
| | | | be warranted | |
| High | N/A | Moderate or | Request and | High |
| | | high | response paths | |
| | | | are | |
| | | | overutilized | |
| | | | while MEMC | |
| | | | queues are | |
| | | | lightly loaded; | |
| | | | cache | |
| | | | controller may | |
| | | | be overutilized | |

TABLE 2
DevLoad-indicating signal 650 information when a memory controller
request queue utilization signal indicates optimal utilization.

| CXL | | CXL | | |
|---|---|---|---|---|
| response | | request | | |
| queue | | queue | | DevLoad- |
| utilization | read-write | utilization | | indicating |
| signal 646 | signal 648 | signal 644 | | signal 650 |
| information | information | information | Comment | information |
| Light | N/A | N/A | The CXL | Light |
| | | | response link | |
| | | | may be | |
| | | | underutilized; | |
| | | | host can | |
| | | | increase traffic | |
| | | | to the device to | |
| | | | test device | |
| | | | performance at | |
| | | | higher | |
| | | | utilization | |
| Optimal | Write heavy | N/A | Write response | Light |
| | | | (NDR) level | |
| | | | high relative to | |
| | | | read response | |
| | | | level | |
| Optimal | Read heavy | N/A | Read response | Optimal |
| | | | level high; | |
| | | | significant | |
| | | | device TX | |
| | | | bandwidth may | |
| | | | be occupied by | |
| | | | read responses | |
| Moderate | Write heavy | N/A | | Optimal |
| Moderate | Read heavy | N/A | | Moderate |
| High | N/A | Light or | CXL device | Moderate |
| | | optimal | request queue | |
| | | | is lightly | |
| | | | loaded, and | |
| | | | MEMC may be | |
| | | | underutilized | |
| | | | in the future; | |
| | | | host may | |
| | | | slightly throttle | |
| | | | traffic to help | |
| | | | mitigate | |
| High | N/A | Moderate or | Significant | High |
| | | high | volume of | |
| | | | requests may | |
| | | | exist in CXL | |
| | | | request queue; | |
| | | | MEMC may be | |
| | | | overutilized in | |
| | | | the future or | |
| | | | central cache | |
| | | | controller may | |
| | | | backpressure | |
| | | | incoming | |
| | | | traffic; high | |
| | | | response queue | |
| | | | volume could | |
| | | | indicate high | |
| | | | cache hit rate | |

TABLE 3
DevLoad-indicating signal 650 information when a memory controller
request queue utilization signal indicates moderate utilization.

| CXL | | CXL | | |
|---|---|---|---|---|
| response | | request | | |
| queue | | queue | | DevLoad- |
| utilization | read-write | utilization | | indicating |
| signal 646 | signal 648 | signal 644 | | signal 650 |
| information | information | information | Comment | information |
| Light | N/A | Light or | MEMC may be | Optimal |
| | | optimal | moderately | |
| | | | loaded, | |
| | | | response path | |
| | | | and CXL | |
| | | | request queue | |
| | | | may be | |
| | | | underutilized | |
| | | | which implies | |
| | | | that incoming | |
| | | | traffic may | |
| | | | have slowed; | |
| | | | no throttling | |
| | | | signal sent to | |
| | | | host and traffic | |
| | | | may be | |
| | | | allowed to | |
| | | | continue | |
| Light | N/A | Moderate or | MEMC and | Moderate |
| | | high | CXL request | |
| | | | queues may be | |
| | | | overutilized; | |
| | | | throttle traffic | |
| | | | lightly to | |
| | | | decongest | |
| | | | forward path | |
| | | | through device | |
| Optimal | N/A | Light or | | Optimal |
| | | optimal | | |
| Optimal | N/A | Moderate or | | Moderate |
| | | high | | |
| Moderate | N/A | N/A | Request and | Moderate |
| | | | response paths | |
| | | | through device | |
| | | | are | |
| | | | overutilized; | |
| | | | throttle | |
| | | | immediately | |
| High | N/A | N/A | Request and | Severe |
| | | | response paths | |
| | | | through device | |
| | | | are | |
| | | | overutilized; | |
| | | | throttle | |
| | | | immediately | |

TABLE 4
DevLoad-indicating signal 650 information when a memory controller
request queue utilization signal indicates high utilization.

| CXL | | CXL | | |
|---|---|---|---|---|
| response | | request | | |
| queue | | queue | | DevLoad- |
| utilization | read-write | utilization | | indicating |
| signal 646 | signal 648 | signal 644 | | signal 650 |
| information | information | information | Comment | information |
| Light | N/A | Light or | MEMC may be | Optimal |
| | | optimal | overutilized, | |
| | | | response path | |
| | | | and CXL | |
| | | | request queue | |
| | | | may be | |
| | | | underutilized | |
| | | | which implies | |
| | | | that incoming | |
| | | | traffic may | |
| | | | have slowed; | |
| | | | provide light | |
| | | | throttling | |
| | | | signal to host | |
| | | | to temper | |
| | | | traffic | |
| Light | N/A | Moderate or | MEMC and | Moderate |
| | | high | CXL request | |
| | | | queues may be | |
| | | | overutilized; | |
| | | | throttle traffic | |
| | | | lightly to | |
| | | | decongest | |
| | | | forward path | |
| | | | through device | |
| Optimal | N/A | N/A | | Moderate |
| Moderate | N/A | N/A | Request and | Moderate |
| | | | response paths | |
| | | | through device | |
| | | | are | |
| | | | overutilized; | |
| | | | throttle | |
| | | | immediately | |
| High | N/A | N/A | Request and | Severe |
| | | | response paths | |
| | | | through device | |
| | | | are | |
| | | | overutilized; | |
| | | | throttle | |
| | | | immediately | |

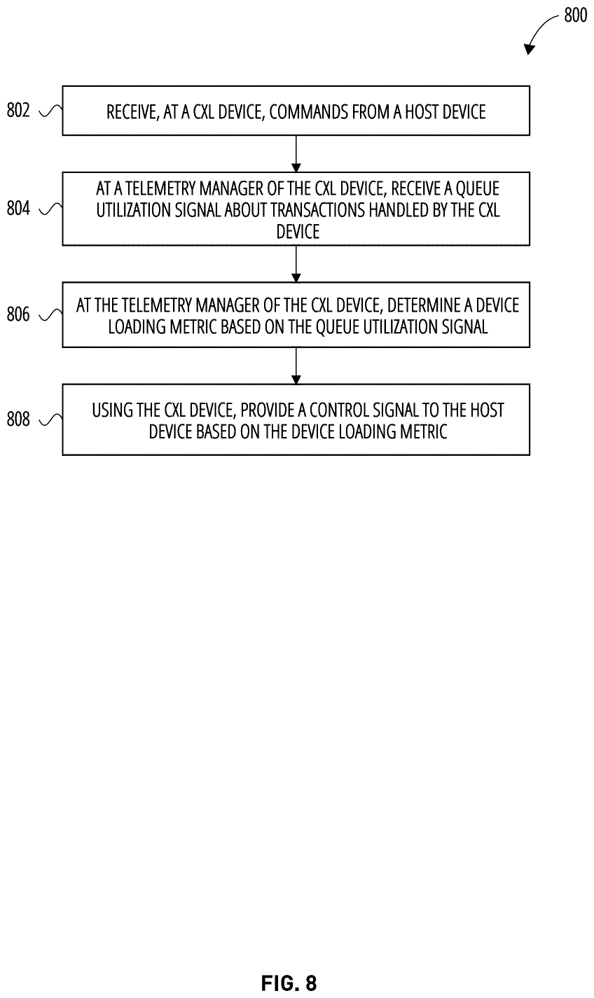

FIG. 8 illustrates generally a first method 800 that can include determining a device loading metric for an accelerator device, such as the example accelerator device 602, in a CXL-based system.

At operation 802, the first method 800 can include receiving, at a first accelerator device such as the accelerator device 602, commands from a host device. In an example, the operation 802 can include receiving the commands using the CXL link 618 at the front end portion 608 of the accelerator device 602. The commands can include, for example, write commands, read commands, or other instructions for operations to be performed by the first accelerator device. In an example, the first accelerator device includes a telemetry manager, such as the telemetry manager 604. The telemetry manager can be configured to monitor or receive thermal information, transaction status information, or other information about one or more portions of the accelerator device and, in response, provide an accelerator device load-indicating signal, or DevLoad-indicating signal 650, to the host device. The host device can use the load-indicating signal to throttle or control future instructions provided to the first accelerator device.

At operation 804, the first method 800 can include, at a telemetry manager of the first accelerator device, receiving a queue utilization signal indicative of a volume of transaction request messages received by, or response messages sent from, the first accelerator device. In an example, the volume of transaction messages includes a count or quantity of request messages or response messages exchanged with, or in response to commands from, the host device.

At operation 806, the first method 800 can include, at the telemetry manager of the first accelerator device, determining a device loading metric for the first accelerator device based on the queue utilization signal. For example, the device loading metric can be based on the queue utilization signal received by the telemetry manager at operation 804.

At operation 808, the first method 800 can include providing a first control signal to the host device based on the device loading metric determined at operation 806. In an example, the first control signal includes information about a utilization or loading of the first accelerator device and its availability or capacity to handle subsequent commands or requests from the host device.

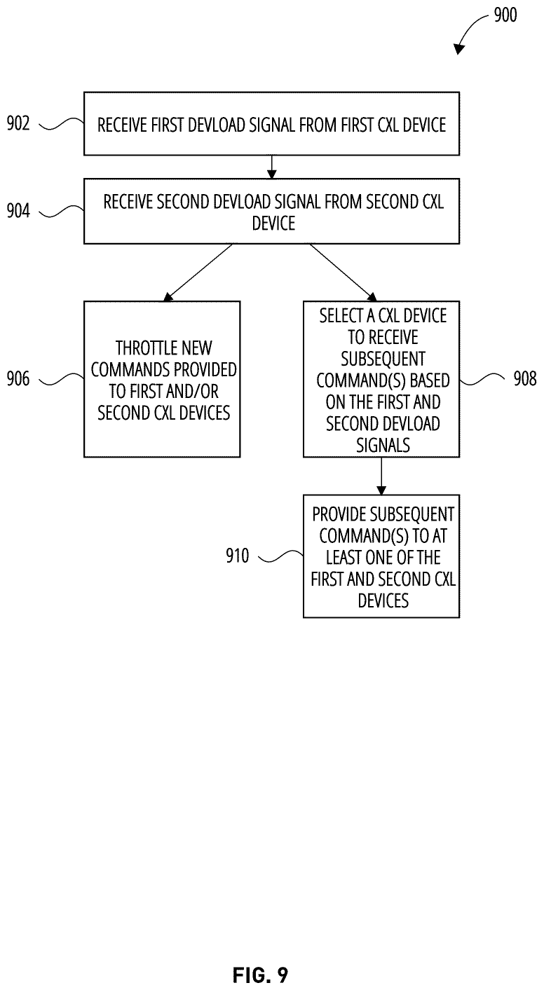

FIG. 9 illustrates generally a second example 900 that can include using information about device loading metrics for multiple accelerator devices to select a device for use in subsequent operations. The second example 900 can include or use a host device that is coupled to at least first and second accelerator devices, such as using a CXL link, and each of the accelerator devices is a separate instance of, for example, the accelerator device 602. The device loading metrics can include information about an occupancy of the accelerator device (e.g., in terms of queue utilization in one or more portions of the accelerator device), information about a thermal characteristic of the accelerator device, or other information about the accelerator device that indicates its capacity to handle additional requests from the host device, such as read or write requests.

At block 902, the second example 900 can include using the host device to receive a first device utilization signal, or first DevLoad signal, from the first accelerator device. At block 904, the second example 900 can include using the host device to receive a second device utilization signal, or second DevLoad signal, from the second accelerator device.

At block 906, the second example 900 can include using the host device to select a particular accelerator device to receive subsequent commands from the host device. The host device can use information from the first and second DevLoad signals and determine which of the first and second accelerator devices is best able to accommodate an additional request or load from the host device. In an example, the first and second DevLoad signals can indicate that each of the first and second accelerator devices is overutilized and, in response, the host device can select a different third accelerator device to receive a later command. At block 908, the second example 900 can include using the host device to provide a subsequent command to the particular accelerator device selected at block 906.

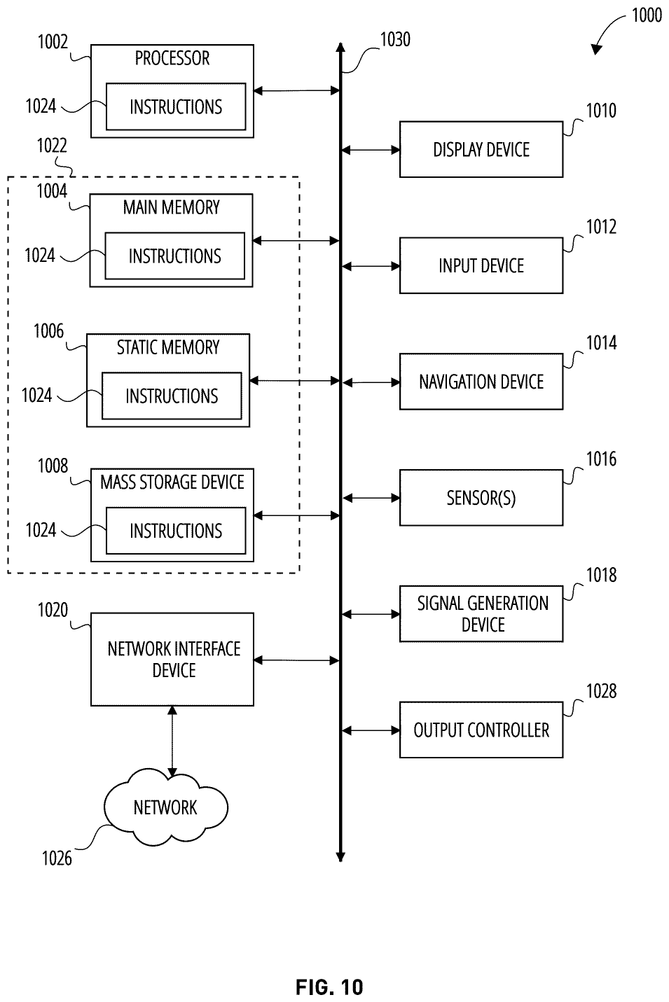

FIG. 10 illustrates a block diagram of an example machine 1000 with which, in which, or by which any one or more of the techniques (e.g., methodologies) discussed herein can be implemented. Examples, as described herein, can include, or can operate by, logic or a number of components, or mechanisms in the machine 1000. Circuitry (e.g., processing circuitry) is a collection of circuits implemented in tangible entities of the machine 1000 that include hardware (e.g., simple circuits, gates, logic, etc.). Circuitry membership (e.g., as belonging to a host-side device or process, or to an accelerator-side device or process) can be flexible over time. Circuitries include members that can, alone or in combination, perform specified operations when operating. In an example, hardware of the circuitry can be immutably designed to carry out a specific operation (e.g., hardwired) for example using the accelerator logic 222 or using a specific command execution unit thereof. In an example, the hardware of the circuitry can include variably connected physical components (e.g., command execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time.

In alternative embodiments, the machine 1000 can operate as a standalone device or can be connected (e.g., networked) to other machines. In a networked deployment, the machine 1000 can operate in the capacity of a server machine, a client machine, or both in server-client network environments. In an example, the machine 1000 can act as a peer machine in peer-to-peer (P2P) (or other distributed) network environment. The machine 1000 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Any one or more of the components of the machine 1000 can include or use one or more instances of the host device 202 or the CXL device 204 or other component in or appurtenant to the computing system 100. The machine 1000 (e.g., computer system) can include a hardware processor 1002 (e.g., the host processor 214, the accelerator logic 222, a central processing unit (CPU), a graphics processing unit (GPU), a hardware processor core, or any combination thereof), a main memory 1004, a static memory 1006 (e.g., memory or storage for firmware, microcode, a basic-input-output (BIOS), unified extensible firmware interface (UEFI), etc.), and mass storage device 1008 or memory die stack, hard drives, tape drives, flash storage, or other block devices) some or all of which can communicate with each other via an interlink 1030 (e.g., bus). The machine 1000 can further include a display device 1010, an alphanumeric input device 1012 (e.g., a keyboard), and a user interface (UI) Navigation device 1014 (e.g., a mouse). In an example, the display device 1010, the input device 1012, and the UI navigation device 1014 can be a touch screen display. The machine 1000 can additionally include a mass storage device 1008 (e.g., a drive unit), a signal generation device 1018 (e.g., a speaker), a network interface device 1020, and one or more sensor(s) 1016, such as a global positioning system (GPS) sensor, compass, accelerometer, or other sensor. The machine 1000 can include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the hardware processor 1002, the main memory 1004, the static memory 1006, or the mass storage device 1008 can be, or include, a machine-readable media 1022 on which is stored one or more sets of data structures or instructions 1024 (e.g., software) embodying or used by any one or more of the techniques or functions described herein. The instructions 1024 can also reside, completely or at least partially, within any of registers of the hardware processor 1002, the main memory 1004, the static memory 1006, or the mass storage device 1008 during execution thereof by the machine 1000. In an example, one or any combination of the hardware processor 1002, the main memory 1004, the static memory 1006, or the mass storage device 1008 can constitute the machine-readable media 1022. While the machine-readable media 1022 is illustrated as a single medium, the term “machine-readable medium” can include a single medium or multiple media (e.g., a centralized or distributed database, or associated caches and servers) configured to store the one or more instructions 1024.

The term “machine readable medium” can include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks.

In an example, information stored or otherwise provided on the machine-readable media 1022 can be representative of the instructions 1024, such as instructions 1024 themselves or a format from which the instructions 1024 can be derived. This format from which the instructions 1024 can be derived can include source code, encoded instructions (e.g., in compressed or encrypted form), packaged instructions (e.g., split into multiple packages), or the like. The information representative of the instructions 1024 in the machine-readable media 1022 can be processed by processing circuitry into the instructions to implement any of the operations discussed herein. For example, deriving the instructions 1024 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1024.

In an example, the derivation of the instructions 1024 can include assembly, compilation, or interpretation of the information (e.g., by the processing circuitry) to create the instructions 1024 from some intermediate or preprocessed format provided by the machine-readable media 1022. The information, when provided in multiple parts, can be combined, unpacked, and modified to create the instructions 1024. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1024 can be further transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1020 can include one or more physical jacks (e.g., Ethernet, coaxial, or phone jacks) or one or more antennas to connect to the network 1026. In an example, the network interface device 1020 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1000, and includes digital or analog communications signals or other intangible medium to facilitate communication of such software. A transmission medium is a machine readable medium.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method comprising:
receiving, at a first accelerator device, commands from a host device;
at the first accelerator device:
receiving a queue utilization signal indicative of a volume of transaction request messages received by, or response messages sent from, the first accelerator device based on the commands from the host device;
determining a device loading metric for the first accelerator device based on the queue utilization signal; and
providing a first control signal to the host device, wherein the first control signal includes information about the device loading metric for the first accelerator device.

2. The method of claim 1, comprising, at the host device, apportioning subsequent commands to the first accelerator device and to a second accelerator device based on the first control signal from the first accelerator device.

3. The method of claim 2, comprising, at the host device, receiving a second control signal with information about a device loading metric for the second accelerator device; and
wherein apportioning the subsequent commands is based on the first and second control signals.

4. The method of claim 1, wherein receiving the commands from the host device includes receiving the commands using a compute express link (CXL) interconnect, and wherein providing the first control signal to the host device includes using the CXL interconnect.

5. The method of claim 4, wherein at least a portion of the first control signal is provided to the host device together with each flow control unit (FLIT) communicated from the first accelerator device to the host device.

6. The method of claim 4, wherein receiving the queue utilization signal includes receiving a CXL response queue utilization signal that indicates a volume of transactions queued for communication from the first accelerator device to the host using the CXL interconnect.

7. The method of claim 4, wherein receiving the queue utilization signal includes receiving a CXL request queue utilization signal that indicates a quantity of transactions queued for further processing by compute resources of the first accelerator device.

8. The method of claim 7, wherein the CXL request queue utilization signal includes information about a utilization of a cache controller on the first accelerator device.

9. The method of claim 1, wherein receiving the queue utilization signal includes receiving a memory controller request queue utilization signal from a memory controller that comprises a portion of the first accelerator device.

10. The method of claim 1, wherein receiving the queue utilization signal includes receiving a memory controller response queue utilization signal from a memory controller that comprises a portion of the first accelerator device.

11. The method of claim 1, comprising determining a read/write ratio for transactions processed by the first accelerator device, the ratio based on a number of data response (DRS) messages and a number of no data response (NDR) messages queued for communication from the first accelerator device to the host device; and
wherein determining the device loading metric includes using the determined read/write ratio.

12. The method of claim 1, further comprising, at a telemetry manager of the first accelerator device, receiving a thermal status signal indicative of a temperature of a portion of the first accelerator device, and determining the device loading metric about the first accelerator device based on the thermal status signal and the queue utilization signal.

13. The method of claim 1, further comprising, at the host device:
receiving the control signal from the first accelerator device and at least one other control signal from a second accelerator device; and
based on the control signals, selecting a particular one of the first and second accelerator devices to receive a subsequent command.

14. The method of claim 1, further comprising, at the host device:
receiving the control signal from the first accelerator device;
based on the control signal, classifying the first accelerator device as underutilized, overutilized, or optimally utilized; and
selecting the first accelerator device or a different accelerator device coupled to the host device to perform a subsequent command based on the classification of the first accelerator device.

15. The method of claim 14, wherein classifying the first accelerator device includes using information from the control signal about one or more of a request path loading status, a response path loading status, a read/write transaction ratio for the first accelerator device, and a thermal status for the first accelerator device.

16. A system comprising:
a host device coupled to multiple accelerator devices using an interconnect; and
a first accelerator device of the multiple accelerator devices, the first accelerator device including:
a first controller configured to manage transactions with the host device via the interconnect;
a memory controller configured to manage transactions with a memory; and
a telemetry manager configured to receive at least one of a request queue utilization signal and a response queue utilization signal from the first controller or from the memory controller and, based on the at least one utilization signal, provide a device utilization-indicating DevLoad signal to the host device via the first controller.

17. The system of claim 16, wherein the first accelerator device includes a cache controller coupled to a cache memory, and wherein the telemetry manager is configured to provide the device utilization-indicating signal based on information about a utilization of the cache controller.

18. The system of claim 16, wherein the first accelerator device includes a thermal manager configured to receive temperature information about at least a portion of the first accelerator device, and wherein the telemetry manager is configured to provide information about a temperature of the first accelerator device in the DevLoad signal.

19. The system of claim 16, wherein the host device is coupled to the multiple accelerator devices using a compute express link (CXL) interconnect.

20. The system of claim 19, wherein the first controller is configured to include information about the DevLoad signal in each FLIT communicated to the host device using the interconnect.
